(19) United States
(12) Patent Application Publication
(10) Pub. No.: US 2025/0308410 A1
(43) Pub. Date: Oct. 2, 2025

(54) WASH-OFF LABEL

(71) Applicant: Specialty Printing, LLC, Windsor, CT (US)

(72) Inventors: William T. Bailey, Ellington, CT (US); Lance Doyle, Tolland, CT (US)

(21) Appl. No.: 19/089,726

(22) Filed: Mar. 25, 2025

Related U.S. Application Data
(60) Provisional application No. 63/570,010, filed on Mar. 26, 2024.

(51) Int. Cl. G09F 3/04; G09F 3/02

(52) U.S. Cl. CPC G09F 3/04; G09F 2003/0208; G09F 2003/0222; G09F 2003/0229

(57) ABSTRACT

A wash-off label includes a sheet, an adhesive layer, and a deadener material. The deadener material forms a deadener outer ring and a plurality of deadener internal channels. The adhesive layer is arranged between the sheet and the deadener material. The deadener material may include a varnish. The deadener material advantageously makes the wash-off labels easily and reliably able to be released from many kinds of surface types and surface material types.

### CROSS-REFERENCE TO RELATED APPLICATION

This application claims priority to U.S. Provisional Patent Application No. 63/570,010, filed Mar. 26, 2024, which is hereby incorporated by reference in its entirety.

### BACKGROUND

Adhesive labels are widely used to display information on packaging, containers and other articles. Often times, it is desirous to configure a label, such as a pressure sensitive adhesive label, so that the label can be strongly affixed to a surface without risk of prematurely delaminating from the surface. However, for many label applications, there comes a time where it is desirous to be able to easily and reliably remove the label from the surface.

For example, labels are often applied to a reusable container for produce. When the reusable container has served its function and transported a quantity of produce from one facility to another (e.g. from a farm to a grocery store), the reusable container is cleaned and repurposed to be used again. During cleaning, it is desirous to wash off the label(s) affixed to the container. However, many labels, such as pressure sensitive labels, are not easily removable. Even when a technician washes the container with water (or other fluid), the label(s) may still be fully or partially stuck to the container. The time spent by the technician to remove the label(s) by hand or with tools is burdensome, costly and time-consuming.

### SUMMARY

The present disclosure advantageously provides wash-off labels and methods of making wash-off labels, such as pressure sensitive wash-off labels, where the labels are easily and reliably removed from a surface with fluid washing.

In some embodiments, an exemplary wash-off label includes a sheet, an adhesive layer, and a deadener material, the deadener material forming a deadener outer ring and a plurality of deadener internal channels. The adhesive layer is arranged between the sheet and the deadener material.

In some embodiments, an exemplary wash-off label includes a sheet, and an adhesive layer. The adhesive layer is patterned to define an outer ring along the perimeter of the sheet of no adhesive and a plurality of internal channels of no adhesive.

### BRIEF DESCRIPTION OF THE DRAWINGS

FIG. 1 shows a cross-sectional view of a wash-off label in accordance with the present disclosure;

FIG. 2 shows a bottom side view of the label of FIG. 1; and

FIG. 3 shows a roll of wash-off labels adhered to a siliconized liner in accordance with the present disclosure.

### DETAILED DESCRIPTION

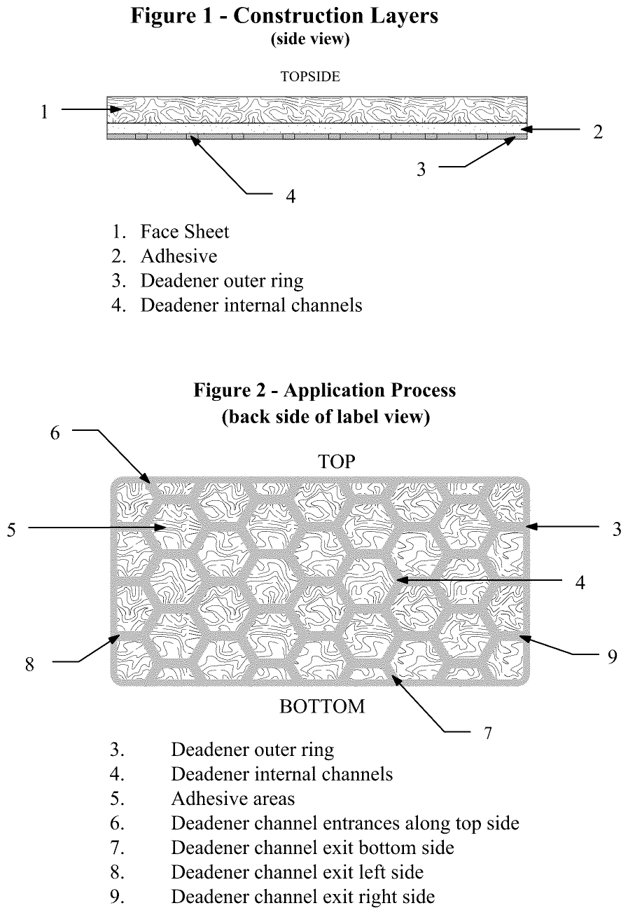

FIG. 1 shows a cross-sectional view of a wash-off label according to the present disclosure. The label includes a face sheet 1 (which may be pre-printed with information or blank for later printing), an adhesive 2 coated to the face sheet 1, and deadener material forming a deadener outer ring 3 and a plurality of deadener internal channels 4. The adhesive 2 is arranged between the face sheet 1 and the deadener material 3, 4. The face sheet 1 may be made of any conventional material, including material having pre-printed information or material configured to be printed on. In other words, the face sheet 1 may be shipped from the manufacturer with all or some of the printed matter already printed on the sheet 1 or the sheet 1 may be printed on by the customer before being applied to a surface.

FIG. 2 shows a bottom side view of the label. From this view, it can be seen that the deadener internal channels 4 are arranged in a honeycomb pattern such that there are a plurality of adhesive areas 5 delimited by the deadener internal channels 4. There are also a plurality of adhesive areas 5 delimited by the deadener internal channels 4 and the deadener outer ring 3. Advantageously, the deadener is applied in a pattern that is continuous without barrier from any point of the outer ring 3 deadened border.

The deadener outer ring 3 and/or deadener internal channels 4 define one or more entrances 6 (but preferably a plurality of entrances 6) on at least one side of the label, which are shown on the top of the view of FIG. 2. The deadener outer ring 3 and deadener internal channels 4 also define one or more exits 7 (but preferably a plurality of exits 7) on a different side of the label (preferably the opposite side of the entrance(s) 6), which are shown on the bottom of the view of FIG. 2.

The label preferably includes one or more additional exits on other sides of the label. For instance, as shown in FIG. 2, there are a plurality of deadener exit channels 8 on the left side and deadener exit channels 9 on the right side of the label.

It should be understood that the entrances 6 and exits 7-9 described above are functionally equivalent and depend on the side of the label that pressurized water (or other fluid) is applied during the wash-off process. For example, water (or other fluid) could enter an “exit” if applied to that side of the label during the wash-off process and the fluid would exit one or more of the “entrances” 6 and/or exits 7-9 described above.

The deadener 3, 4 serves to completely or at least partially deactivate or hinder the effectiveness of the adhesive 2 in the areas where the deadener 3, 4 is arranged. Thus, the adhesive 2 does not adhere the face sheet 1 of the label to a surface in those areas where the deadener 3, 4 is arranged, or at least does not adhere as effectively as in the adhesive areas 5 where the deadener 3, 4 is not arranged.

The deadened areas 3, 4 can be achieved through applying deadener material, as described above, or can be achieved without deadener material at all by applying the adhesive 2 layer in a patterned way such that no adhesive is applied at the ring 3 and internal channel 4 areas.

In operation, once the label is affixed to a surface, a user may wash off the label by directing water and/or other fluid at one of the edges of the label. The water/fluid will enter one or more of the entrances/exits 6-9 and mechanically force the label away from the surface to which it is affixed. The deadener 3, 4 at the entrances 6 and exits 7-9 serves to aid in allowing fluid under pressure to enter the space between the sheet 1 and the surface to which the sheet 1 is applied; at least more so than a sheet 1 without the ring 3 and/or channels 4 patterned therein. Advantageously, the label of FIG. 2 includes entrances/exits 6-9 on every side of the label (i.e. each of the four sides) such that a user may direct water/fluid at any edge and reliably find an entrance/exit 6-9 for the water/fluid to enter and reliably release the label from the surface to which it is affixed. This is advantageous as the deadener 3, 4 may or may not be visible to the naked eye. However, it is within the scope of the present disclosure for the deadener 3, 4 to include coloring to make the deadener 3, 4 and/or entrances 6 or exits 7-9 visible to the naked eye, or visible with the use of black light. In some embodiments, the face sheet 1 can include indications such as arrows or coloring to indicate the presence or locations of deadener 3, 4 or entrances 6 or exits 7-9.

Having entrances 6 and exits 7-9 on all sides of the label also serves to allow the fluid applied during a wash-off process to exit from any surrounding edge of the label. For example, in a four-sided label, fluid entering an entrance 6 from one edge may exit from any or all of the exits 7-9 on the remaining 270° perimeter of the label, which assists in releasing the label from the surface to which it is applied.

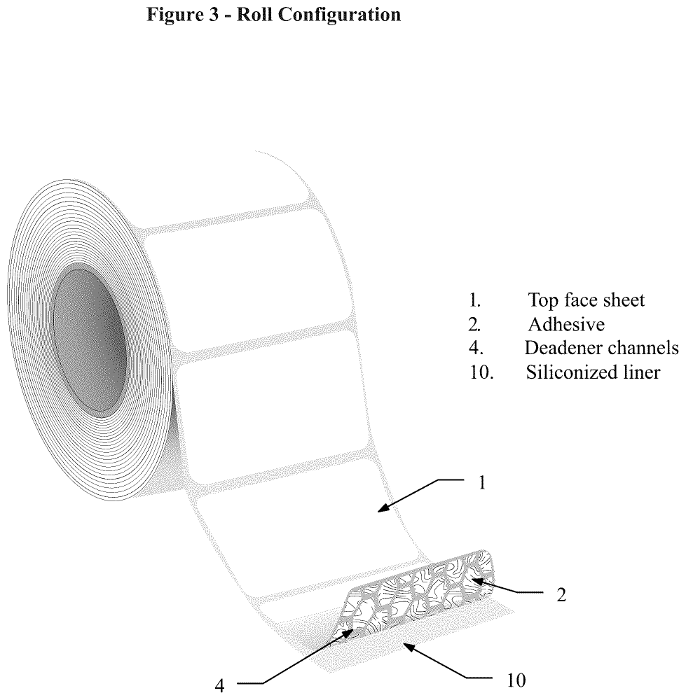

Referring to FIG. 3, an exemplary roll of wash-off labels are shown adhered to a siliconized liner 10. While the wash-off labels are shown in FIG. 3 as being arranged as a liner-type label, it should be readily understood by those of ordinary skill in the art that the inventive patterned outer ring and internal channel arrangement (either patterned with deadener applied or patterned with no adhesive in those areas) can also be implemented in liner-less label applications.

A method of washing off a label according to the present disclosure includes directing pressurized fluid (e.g. water) at an edge of a label of FIGS. 1-3, which results in water entering one or more of the entrances 6, traveling through the internal channels 4 and exiting from one or more of the exits 7-9. The introduction of the pressurized fluid in this manner causes the face sheet 1 to fully delaminate from a surface to which the wash-off label is applied. The pressurized fluid can enter and exit between the sheet 1 and the surface the label is applied without barrier. In other words, through the patterning of the deadener material 3, 4 and/or patterned adhesive layer 2, the pressurized fluid has a continuous path from one edge of the label to at least another edge of the label during the wash-off process.

The face sheet 1 may be any kind of material, such as and without limitation, paper pulp material or film (PET, BOPP, vinyl, etc.). The adhesive 2 may be any type or kind of adhesive. Advantageously, the novel patterns of the present disclosure work well with pressure sensitive adhesives that conventionally were not well-suited for wash-off applications. For example and without limitation, the adhesive 2 may be acrylic adhesive or hot melt adhesive. Importantly, the inventive wash-off labels of the present application do not necessarily need to be configured with water-soluble adhesives 2. Rather, the adhesive 2 can be a non-water soluble adhesive type and still be easily released from a surface if patterned with deadening material 3, 4 or lack of adhesive as disclosed herein.

While the deadener outer ring 3 is shown as being continuous (i.e. in which the label border is completely deadened 360° around the die shape of the label), in some embodiments the deadener outer ring 3 (or outer ring 3 of no adhesive) is not continuous.

While the deadener internal channels 4 are shown in a honeycomb pattern, it is within the scope of the present disclosure for the pattern to be virtually any kind of pattern. For example, other patterns that define the adhesive areas 5 as other geometric shapes are within the scope of the present disclosure, such as triangles, circles, ovals, quadrilaterals, pentagons, etc., or any combination thereof. The adhesive areas 5 can be non-standard shapes or designs as well.

In some embodiments, the deadener material 3, 4 is applied directly over the top of a pressure sensitive adhesive 2 using a flexographic printing process. The deadener material 3, 4 may comprise varnish and/or any other material that blocks (or interferes with) the tack of the adhesive layer 2. For example, the deadener material 3, 4 can be a silicone-based, UV-curable material or a water-based, air-curable material. If UV-curable, the deadener material 3, 4 can be applied or printed to the adhesive layer 2 and exposed to UV light to cure the deadener material 3, 4 onto the adhesive layer 2. In some embodiments, the deadener 3, 4 is applied at a weight or thickness that achieves 100% blockage of any adhesive tack in the areas in which the deadener 3, 4 is covering the adhesive 2. Although there are areas that have deadened material 3, 4 and those that do not, the thickness of the deadener material 3, 4 can be small enough that the sheet 1 of the label still lies substantially flat on a surface when observed. In other words, the presence of the deadener material 3, 4 does not necessarily cause the sheet 1 to be raised or depressed when applied to a surface. The deadener material 3, 4 may optionally be included with a UV colorant and can be marked with a brand name or certification so that the user washing the label off can confirm that the label is a certified label if desired.

The present disclosure advantageously provides wash-off labels and method of making wash-off labels where the wash-off label is easily and reliably able to be released from many kinds of surface types and surface material types. For example and without limitation, the wash-off labels of the present disclosure are reliably and easily released from surfaces made of plastic, glass, metal, wood, polymer blend, and the like.

As will be recognized by those of ordinary skill in the pertinent art, numerous modifications and substitutions can be made to the above-described embodiments of the present disclosure without departing from the scope or spirit of the disclosure.

What is claimed is:

1. A wash-off label comprising:
a sheet;
an adhesive layer; and
a deadener material, the deadener material forming a deadener outer ring and a plurality of deadener internal channels;
wherein the adhesive layer is arranged between the sheet and the deadener material.

2. The wash-off label according to claim 1, wherein the deadener material comprises a varnish.

3. The wash-off label according to claim 1, wherein the deadener material is arranged in a honeycomb pattern such that there are a plurality of adhesive areas delimited by the deadener internal channels.

4. The wash-off label according to claim 3, wherein a plurality of adhesive areas are delimited by the deadener internal channels and the deadener outer ring.

5. The wash-off label according to claim 1, wherein the deadener material is applied in a pattern that is continuous without barrier from any point of the deadener outer ring.

6. The wash-off label according to claim 1, wherein the sheet includes indications indicating the presence of deadener entrances.

7. The wash-off label according to claim 6, wherein the indications are arrows.

8. The wash-off label according to claim 1, wherein the adhesive layer comprises a pressure sensitive adhesive.

9. The wash-off label according to claim 1, wherein the adhesive layer comprises a non-water soluble adhesive.

10. A roll comprising:
a liner; and
a plurality of wash-off labels according to claim 1.

11. The roll according to claim 10, wherein the liner is siliconized.

12. A wash-off label comprising:
a sheet; and
an adhesive layer;
wherein the adhesive layer is patterned to define an outer ring along the perimeter of the sheet of no adhesive and a plurality of internal channels of no adhesive.

13. The wash-off label according to claim 12, wherein the adhesive layer comprises a pressure sensitive adhesive.

14. The wash-off label according to claim 12, wherein the adhesive layer is honeycomb patterned such that there are a plurality of adhesive areas delimited by the internal channels of no adhesive.

15. The wash-off label according to claim 14, wherein a plurality of adhesive areas are delimited by the internal channels and the outer ring of no adhesive.

16. The wash-off label according to claim 12, wherein the adhesive layer is patterned such that the internal channels are continuous without barrier from any point of the outer ring.

17. The wash-off label according to claim 12, wherein the sheet includes indications indicating the presence of internal channel entrances.

18. The wash-off label according to claim 17, wherein the indications are arrows.

19. A roll comprising:
a liner; and
a plurality of wash-off labels according to claim 12.

20. The roll according to claim 19, wherein the liner is siliconized.
